(19) United States
(12) Patent Application Publication
(10) Pub. No.: US 2003/0065984 A1
(43) Pub. Date: Apr. 3, 2003

(54) Processor device equipped with flash memory and debugger apparatus

(76) Inventors: Kazuyoshi Takeda, Chino-shi (JP); Takashi Kashine, Chino-shi (JP)

Correspondence Address: HARNESS, DICKEY & PIERCE, P.L.C., P.O. BOX 828, BLOOMFIELD HILLS, MI, 48303, US

(21) Appl. No.: 10/241,002

(22) Filed: Sep. 10, 2002

(30) Foreign Application Priority Data
Sep. 10, 2001 (JP) 2001-274132

(51) Int. Cl. H02H 3/05

(52) U.S. Cl. 714/42

(57) ABSTRACT

A processor apparatus (microcomputer) 1 is equipped with a flash memory 17 which performs processing according to a processing program and rewriting for the flash memory. The flash memory-equipped processor apparatus comprises a mode switch register 18a that sets a normal mode that performs operations according to a processing program (application program) AP and a self-rewriting mode that performs rewriting operations for the flash memory during execution of the processing program. When processes in a self-rewriting mode are programmed in the processing program AP, a control device (CPU) 2 sets, during execution of the processing program AP, the mode switch register 18a to the self-rewriting mode, and performs a rewriting operation for the flash memory 17 according to a rewriting program (self-rewriting program) WP.

### BACKGROUND OF THE INVENTION

1. Technical Field

The present invention relates to a flash memory-equipped processor apparatus, such as, a microcomputer (hereafter called “microcomputer”), and a debugger apparatus that debugs the processor apparatus, and also a flash memory-equipped processor apparatus which can perform rewriting for the flash memory even when processes are being executed according an application program or the like and a debugger apparatus therefore.

2. Discussion

A flash memory built-in type microcomputer equipped with a flash memory that can change its program and data is known as a processor apparatus equipped with flash memory. Flash memory built-in type microcomputers are used for the development of application programs or the like, or used in an initial stage of mass-production before switching to mask ROM (Read Only Memory) built-in type microcomputers. Generally, a flash memory built-in type microcomputer has a normal mode that executes an application program that is stored in the flash memory and a rewriting mode that performs rewriting for the flash memory, and is equipped with a mode switch terminal for switching the two modes. For example, when the user performs rewriting for the flash memory, a power supply voltage is applied to the mode switch terminal to switch to the rewriting mode, and a rewriting program stored in a ROM or the like in the flash memory built-in type microcomputer is executed to thereby perform rewriting for the flash memory. Then, after the rewriting operation, the mode switch terminal is grounded to switch to the normal mode, and the application program is executed by the flash memory built-in type microcomputer to perform the application. Note that the flash memory is divided into many sectors, and the user designates those sectors to be rewritten. Also, since the flash memory has a limit in the number of rewriting operations, the user designates those sectors that do not exceed the limit.

However, in the conventional flash memory built-in type microcomputer, rewriting operations for the flash memory cannot be performed during execution of the application program. Accordingly, in this type of flash memory built-in type microcomputer, data generated during the operation of an application program (for example, results of a game, key-less entry code that changes each time the key is opened, and the like) cannot be stored in the flash memory. As a countermeasure, the microcomputer may be equipped with a nonvolatile data storage such as an EEPROM (Electrically Erasable Programmable Read Only Memory), and data may be stored in the EEPROM. However, the EEPROM can store only a limited amount of data, and it is difficult to fabricate an EEPROM and a microcomputer on a single chip. Further, when applied products with microcomputers mounted thereon include analog elements, there may be cases where the specification accuracy cannot be achieved due to manufacturing variations (in the semiconductor process and the like) among the products, and there may be cases where the microcomputers themselves cannot be independently adjusted due to variations in external parts to be connected to the microcomputers. For this reason, the products need adjustments after completion of their manufacture. However, adjustment amounts may differ from one product to another, which cannot be accommodated by writing with a writer device. Therefore, this must be coped with, after completion of the manufacture, by generating adjustment data for each product by a program, and writing the generated adjustment data in each product.

Also, when a rewriting operation for a flash memory occurs during the operation of an application program, a variety of problems may be created as follows. For example, as the power required for operating the application and the power required for rewriting are consumed at the same time, there is a possibility that the rewriting operation cannot be performed due to the lowered voltage. Also, when an application program has a bug, for example, when a rewriting process for the flash memory is programmed at wrong locations, data and programs stored in the flash memory may possibly be destroyed. Also, if data or the like generated during the operation of an application program is stored in a flash memory, rewriting operations on the flash memory are frequently performed, and there is a possibility that the number of rewriting operations for sectors may exceed the limit. Furthermore, while an application program is being executed, the oscillation circuit generates a clock having a frequency required for the operation of the application. Therefore, unless another oscillation circuit exclusively for the flash memory is provided, a clock having a frequency for generating high-speed and highly accurate cycles that are necessary for accesses to the flash memory would not be obtained.

Also, when a microcomputer that is capable of performing rewriting operations for a flash memory during the operation of an application program is debugged, a variety of problems could possibly be created as follows. For example, when a rewriting operation is performed for the flash memory during the debugging operation, and the debugger performs step-executions of the rewriting program or breaks, there is a possibility that data and programs stored in the flash memory may be destroyed. Also, because sources of an application program displayed on a display device of the debugger are read out from a storage device on the debugger side, if an application program stored in a flash memory on a target board of the microcomputer is rewritten, there is a possibility that the application program displayed by the debugger and the application program executed on the target board may not be identical or in accordance with each other.

In view of the above, it is an object of the present invention to provide a flash memory-equipped processor apparatus in which rewriting operations for the flash memory can be stably performed even during an operation according to an application program or the like, and a debugger apparatus that performs debugging of the processor apparatus.

### SUMMARY OF THE INVENTION

A flash memory-equipped processor apparatus in accordance the present invention which solves the problems pertains to a flash memory-equipped processor apparatus, which performs processing according to a processing program and rewriting for the flash memory, characterized in comprising: a mode switch register that sets a normal mode that performs processing according to the processing program and a self-rewiting mode that performs rewriting for the flash memory during execution of the processing program; a rewriting program that programs a writing process for the flash memory; and a control device that executes the processing program, wherein, when the processing program programs a processing with the self-rewriting mode, the control device sets, during execution of the processing program, the mode switch register to the self-rewriting mode, and performs rewriting for the flash memory according to the rewriting program.

With the flash memory-equipped processor apparatus, when a process in the self-rewriting mode is programmed in the processing program, the processor apparatus internally sets the mode switch register to the self-rewriting mode, and executes the rewriting program. Therefore, the processor apparatus can perform rewriting operations for the flash memory while the processing program is operated.

Also, the flash memory-equipped processor apparatus is characterized in that the flash memory is divided into a plurality of sectors, the control device writes test data in a specified sector of the flash memory after the mode switch register is set to the self-rewriting mode, and after writing, performs rewriting for the flash memory when data stored in the specified sector accords with the test data.

With the flash memory-equipped processor apparatus, before a rewriting operation is formally performed for the flash memory, a determination is made as to whether or not test data can be normally written in a specified sector. If a rewriting operation cannot be normally performed due to a lowered voltage or some other reasons, the rewriting operation for the flash memory can be stopped.

Also, the flash memory-equipped processor apparatus is characterized in further comprising a memory device that stores data, wherein the processing program programs a process of writing verification data in a predetermined region of the memory device before processing in the self-rewriting mode, the control device writes verification data in a predetermined region of the memory device before setting the mode switch register to the self-rewriting mode according to the processing program, and after setting the mode switch register to the self-rewriting mode, performs rewriting for the flash memory when data stored in the predetermined region of the memory device accords with the verification data.

With the flash memory-equipped processor apparatus, since a process for writing verification data in a predetermined region of the memory device to be performed before processing in the self-rewriting mode is programmed in the processing program, a determination is made, before a rewriting operation is formally performed for the flash memory, as to whether or not verification data is written in a predetermined region of the memory device. Accordingly, a determination can be made if the self-rewriting mode is set according to a normal command in the processing program.

Also, the flash memory-equipped processor apparatus is characterized in that the flash memory is divided into a plurality of sectors, wherein the sectors have rewriting number counters that set rewriting numbers, the control device reads out a rewriting number set at the rewriting number counter of the sector to be rewritten after setting the mode switch register to the self-rewriting mode, and performs rewriting of the sector to be rewritten when the rewriting number is at a rewriting limit number or lower, and performs rewriting of a sector different from the sector to be rewritten when the rewriting number exceeds over the rewriting limit number.

With the flash memory-equipped processor apparatus, a determination is made as to whether or not the number of rewriting operations for the sector to be rewritten that is designated by the processing program or the like is the rewriting limit number or lower, and it is changed to a different sector when the rewriting limit number is exceeded. Accordingly, rewriting operations can be performed for each of the sectors up to its rewriting limit number, and rewriting operations for the flash memory can be continued even when the number of rewriting operations for a certain sector reaches the rewriting limit number.

Also, the flash memory-equipped processor apparatus is characterized in further comprising a first oscillation device that generates a first clock having a constant frequency, and a second oscillation device that generates a second clock, wherein the control device calculates a specified cycle with the second clock based on a constant time formed from the first clock.

With the flash memory-equipped processor apparatus, even when the second oscillation device is generating the second clock with a frequency required for operations by the processing program, a specified cycle with the second clock can be calculated based on a constant time formed from the first clock, such that a cycle that is required for rewriting operations for the flash memory can be generated based on the second clock.

A debugger apparatus in accordance with an embodiment of the present invention which solved the problems pertains to a debugger apparatus that debugs the flash memory-equipped processor apparatus wherein, when a start of execution of the rewriting program is detected during debugging, the execution of the rewriting program is not stopped halfway through thereof.

With the debugger apparatus, when a start of execution of the rewriting program is detected during debugging, the execution of the rewriting program is not stopped halfway through thereof. As a result, programs and data stored in the flash memory would not be destroyed due to stopping of the execution of the rewriting program halfway through thereof.

Furthermore, the debugger apparatus is characterized in that, when the rewriting program is executed during debugging, information indicating that rewriting is performed at the flash memory is output.

With the debugger apparatus, when the rewriting program is executed during debugging, information indicating that rewriting is performed at the flash memory is output. Therefore, even when the processing program being displayed on the debugger apparatus as a result of a rewriting operation in the self-rewriting mode does not accord with the processing program stored in the flash memory, such an incident can be recognized by the user.

It is noted that the processor apparatus is an apparatus that performs executions according to a variety of processing programs, and is for example a microcomputer, DSP (Digital Signal Processor), sequencer or the like. Also, the test data is data which is different from data lastly written in a specified sector, for confirming if a rewriting operation can be performed in the flash memory, and is for example fixed data that is different from data lastly written in a specified sector, data in which a constant number is added to data lastly written in a specified sector, or the like. Also, the memory device is any memory device that is provided in a processor apparatus, and is for example a RAM (Random Access Memory), register, a volatile memory or the like. Also, the verification data is data which is different from data lastly written in a specified region of the memory device, for verifying if a rewriting program is executed according to a normal command of the processing program, and is for example fixed data that is different from data lastly written in a specified region, data in which a constant number is added to data lastly written in a specified region, or the like.

### BRIEF DESCRIPTION OF THE DRAWINGS

FIG. 1 is a block diagram of the microcomputer in accordance with an embodiment of the present invention.

FIG. 2 shows memory maps of the microcomputer, wherein (a) shows the case in the normal mode, and (b) shows the case in the self-rewriting mode.

FIG. 3 shows a physical structure of the flash memory in accordance with an embodiment of the present invention.

FIG. 4 shows flowcharts of the rewriting process in the self-rewriting mode in the microcomputer, wherein (a) is a flowchart of processes performed by an application program, and (b) is a flowchart of processes performed by a self-rewriting program.

FIG. 5 shows flowcharts of a rewriting test process in the microcomputer, wherein (a) is a flowchart of processes performed by the application program, and (b) is a flowchart of processes performed by the self-rewriting program.

FIG. 6 shows flowcharts of a program crash handling process (register) in the microcomputer, wherein (a) is a flowchart of processes performed by the application program, and (b) is a flowchart of processes performed by the self-rewriting program.

FIG. 7 shows flowcharts of a program crash handling process (RAM) in the microcomputer, wherein (a) is a flowchart of processes performed by the application program, and (b) is a flowchart of processes performed by the self-rewriting program.

FIG. 8 shows flowcharts of a rewriting number process in the microcomputer, wherein (a) is a flowchart of processes performed by the application program, and (b) is a flowchart of processes performed by the self-rewriting program.

FIG. 9 is a flowchart of the cycle calculation process performed by the microcomputer in accordance with an embodiment of the present invention.

FIG. 10 shows an overall structure of a debugging system equipped with a debugger in accordance with an embodiment of the present invention.

FIG. 11 shows a flow chart of the self-rewriting mode handling process by the debugger in accordance with the embodiment of the present invention.

FIG. 12 is a flowchart of processes using the self-rewriting mode in a radio controlled watch in which the microcomputer in accordance with the embodiment of the present invention is implemented.

FIG. 13 is a flowchart of processes using the self-rewriting mode in a car navigation device in which the microcomputer in accordance with the embodiment of the present invention is implemented.

### DESCRIPTION OF THE PREFERRED EMBODIMENTS OF THE PRESENT INVENTION

A flash memory-equipped processor apparatus and a debugger apparatus in accordance with embodiments of the present invention will be described below with reference to the accompanying drawings.

A flash memory-equipped processor apparatus in accordance with the present invention has a structure that is equipped with a mode switch register that is capable of switching between a normal mode and a self-rewriting mode with a control device so that rewriting operations can be executed for the flash memory even during execution of an operation by a processing program. In particular, the processor apparatus is structured to perform a rewriting test before a formal rewriting is executed, verify as to whether a self-rewriting mode is set as a result of the normal execution of a processing program, checks the number of rewriting operations for sectors to be rewritten, and generates high-speed and highly accurate cycles for rewriting operations such that rewriting operations for the flash memory are stably conducted even during its operation. Also, the debugger apparatus in accordance with the present invention is structured so as not to perform breaks or step-executions while the flash memory is being rewritten, such that, when the processor apparatus of the present invention performs rewriting operations for the flash memory during debugging, the rewriting operations can be normally performed.

In the present embodiment, the flash memory-equipped processor apparatus in accordance with the present invention is applied to a flash memory built-in type microcomputer. The microcomputer in accordance with the present embodiment is equipped with a CPU (Central Process Unit) serving as a control device, and a mode switch register that sets a normal mode and a self-rewriting mode, executes with the CPU application programs (processing programs) created by the user, and sets with the CPU the mode switch register. It is noted that the microcomputer can be mounted in a watch, and therefore is equipped with a first oscillation circuit that generates a high precision first clock for forming a cycle of 1 Hz (i.e., 1 second), and a second oscillation circuit that generates a plurality of high-speed second clocks for forming cycles necessary for respective applications.

The debugger in accordance with the present embodiment is an apparatus that, through connecting a target board of the microcomputer of the present embodiment to an ICE (In Circuit Emulator), performs debugging while emulating operations of the microcomputer by the ICE.

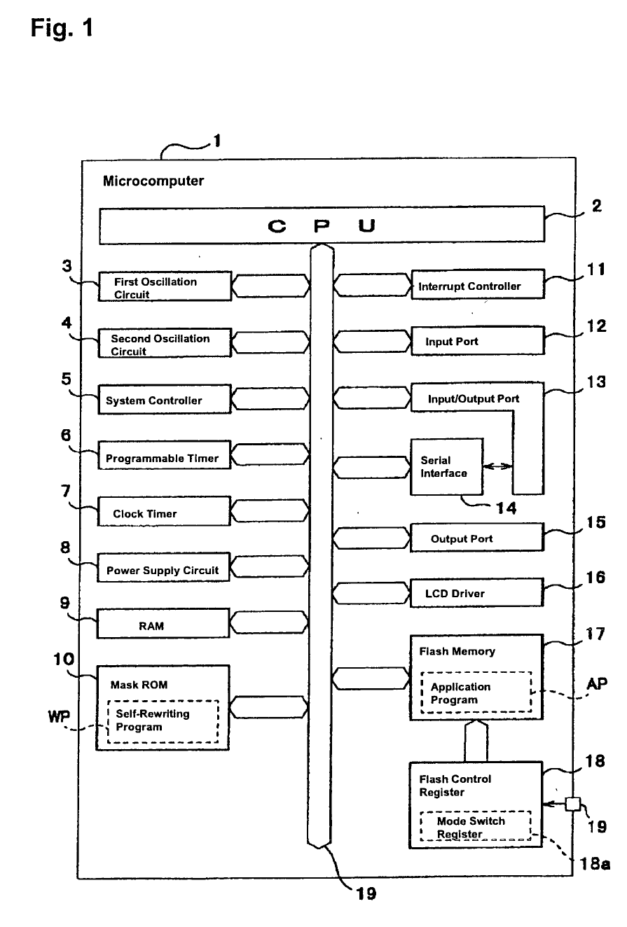

First, referring to FIG. 1, the structure of the microcomputer 1 is described. FIG. 1 is a block diagram of the microcomputer.

The microcomputer 1 is equipped, mainly, with a CPU 2, first oscillation circuit 3, second oscillation circuit 4, system controller 5, programmable timer 6, clock timer 7, power supply circuit 8, RAM 9, mask ROM 10, interrupt controller 11, input port 12, input/output port 13, serial interface 14, output port 15, LCD (Liquid Crystal Display) driver 16, flash memory 17 and flash control register 18.

In the present embodiment, the microcomputer 1 serves as an example of a flash memory-equipped processor apparatus, the CPU 2 serves as a control device, the first oscillation circuit 3 serves as a first oscillation device, the second oscillation circuit 4 cserves as a second oscillation device, and the RAM 9serves as an example of one of the memory devices that may be used in practicing this invention.

The CPU 2 is described. The CPU 2 is a core of the microcomputer 1 that generally controls the microcomputer 1. The CPU 2 executes application programs AP, and performs various calculations and issues various commands according the application programs AP.

The first oscillation circuit 3 is described. The first oscillation circuit 3 is an oscillation circuit that generates a first clock that is a main clock of the microcomputer 1. The first clock is a low-speed and highly accurate clock with a constant frequency, and is used as a system clock when the CPU 2 or the like operate at low speed (low power consumption). It is noted that the first clock, in this embodiment, is an oscillation source that generates 1 Hz (1 second) clock signals.

The second oscillation circuit 4 is described. The second oscillation circuit 4 is an oscillation circuit that generates second clocks that are sub-clocks for the microcomputer 1. The second clocks are high-speed clocks with a plurality of different frequencies, but with lower accuracy than the first clock, and are used as system clocks when the CPU 2 or the like operate at high speed. It is noted that the frequencies of the second clocks change according to respective operations of the applications. When a rewriting operation is performed for the flash memory 17, high-speed clocks are required. In this respect, when a rewriting process is being performed in the self-rewriting mode during the execution of the application program AP, the second oscillation circuit 4 generates second clocks with frequencies necessary for operations by the application program AP.

The system controller 5 is described. The system controller 5 is a controller that sets bus modes and the like according to the system structure of memories or the like.

The programmable timer 6 is described. The programmable timer 6 is a timer that generates cycles that are required for respective operations of the applications based on the first clock or the second clocks. Normally, the programmable timer 6 generates cycles by using the first clock. When high-speed cycles are required by an application, the programmable timer 6 uses the second clocks to generate cycles. In this instance, the second oscillation circuit 4 generates second clocks with frequencies appropriate for cycles that are required by the application. When a rewriting operation is performed for the flash memory 17, a high-speed cycle is required. In this respect, when a rewriting process is being performed in the self-rewriting mode during the execution of the application program AP, the programmable timer 6 generates cycles required for operations by the application program AP by using the second clocks.

The clock timer 7 is described. The clock timer 7 is a timer that generates, based on the first clock, cycles of 1 Hz, 2 Hz, 4 Hz, 8 Hz, 16 Hz, 32 Hz, 64 Hz and 128 Hz. Also, the clock timer 7 generates interrupts of 1 Hz, 2 Hz, 8 Hz and 32 Hz, and sets 1 Hz timer interrupt flag and the like.

The power supply circuit 8 is described. The power supply circuit 8 is a circuit that uses an external power supply source composed of batteries (not shown), and generates all operation voltages required for the microcomputer 1 including the internal logic circuit, first oscillation circuit 3, second oscillation circuit 4, LCD driver 16 and the like.

The RAM 9 is described. The RAM 9 is a memory that temporarily stores data within the microcomputer 1. It is noted that, when rewriting operations are performed for the flash memory 17, writing data are transferred to the RAM 9.

The mask ROM 10 is described. The mask ROM 10 is a read only memory that stores programs or the like that are executed by the CPU 2. It is noted that the mask ROM 10 stores a self-rewriting program WP.

The interrupt controller 11 is described. The interrupt controller 11 is a controller that controls, when multiple interrupts are generated, priority order of these interrupts.

Each of the ports 12, 13 and 15 is described. The input port 12 is an input only port. The input/output ports 13 is a port for input and output. The output port 15 is an output only port.

The serial interface 14 is described. The serial interface 14 is an interface that performs serial communication with external equipment, and sends and receives data through the input/output port 13.

The LCD driver 16 is described. The LCD driver 16 is a driver that drives an LED panel (not shown) according to commands from the CPU 2.

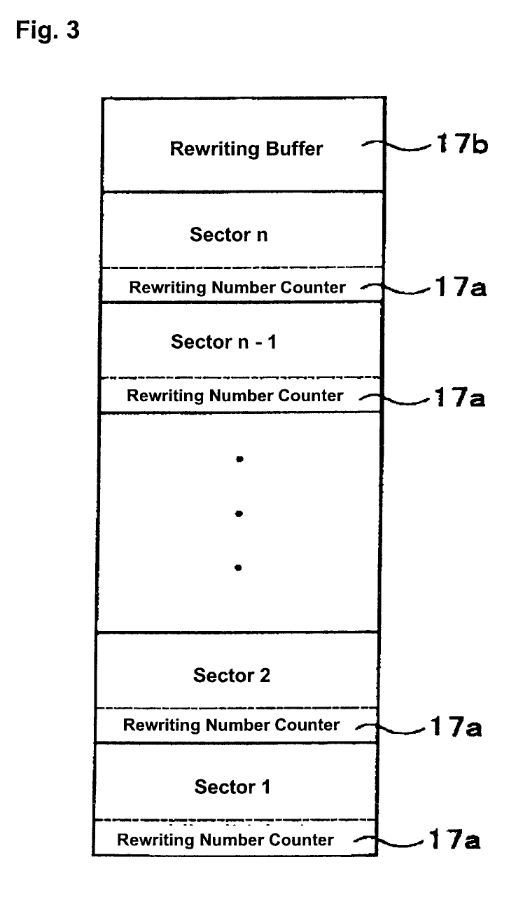

Referring also to FIG. 3, the flash memory 17 is described. FIG. 3 shows s physical structure of the flash memory. The flash memory 17 is divided into multiple sectors 1-n, as shown in FIG. 3, and is capable of rewriting data in units of sectors. Each of the sectors has a capacity of 128 bytes, and is capable or rewriting data 1000 times. Also, each of the sectors is equipped with a rewriting number counter 17a for setting the number of rewriting operations. Further, the flash memory 17 is equipped with a rewriting buffer 17b for temporarily storing writing data for one sector when data is rewritten. It is noted that the flash memory 17 stores programs such as application programs and data.

In the present embodiment, the application program AP serves as an example of a processing program recited in the scope of claimed invention.

The flash control register 18 is described. The flash control register 18 is a resister that temporarily stores data required when a rewriting operation is performed for the flash memory 17. For this purpose, the flash control register 18 includes a register that temporarily stores, for example, addresses of rewriting destinations of the flash memory 17, writing data for the flash memory 17 or the like. Also, the flash control register 18 includes a mode switch register 18a used for setting a normal mode (as its value is set to 1) that executes the application program AP, and a self-rewriting mode (as its value is set to 0) that performs a rewriting operation for the flash memory 17 during execution of the application program AP. It is noted that the mode switch register 18a normally sets the value at 1.

The microcomputer 1 has, besides the normal mode and self-rewriting mode, a rewriting mode that can perform rewriting operations for the flash memory 17 by settings from outside. For this purpose, the microcomputer 1 is equipped with a mode switch terminal 19. When the user wants to perform a rewriting operation for the flash memory 17, for example, a power supply voltage is applied to the mode switch terminal 19 to switch to the rewriting mode.

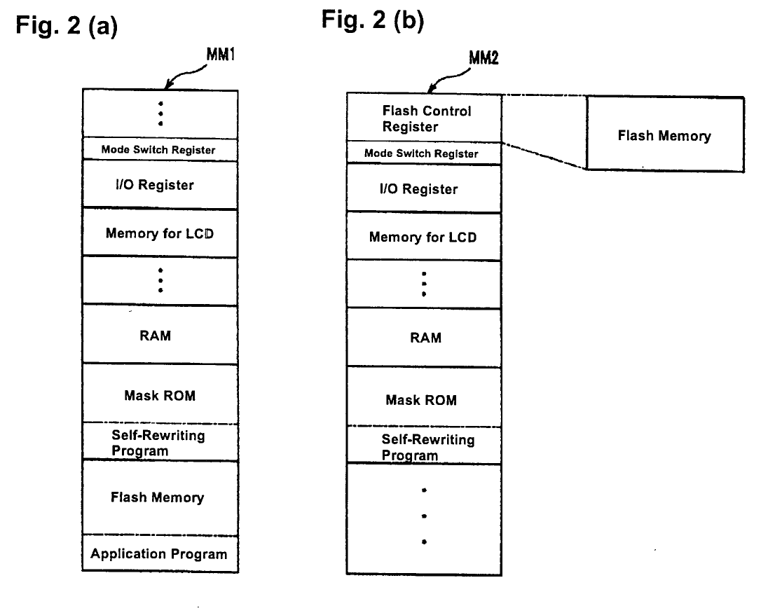

Next, referring to FIG. 2, the memory map of the microcomputer 1 is described. FIG. 2 shows memory maps of the microcomputer, wherein (a) shows the case of normal mode, and (b) shows the case of self-rewriting mode.

The microcomputer 1 maps the address space of the CPU 2 according to values that are set at the mode switch register 18a.

As shown in FIG. 2(a), when the value of the mode switch register 18a is 1 (in the case of normal mode), a memory map MM1 maps, starting from address 0, a memory region for the flash memory 17, a memory region for the mask ROM 10, a memory region for the RAM 9, . . . , a memory region for the LCD, a memory region for the I/O register, a memory region for the mode switch register 18a, . . . It is noted that an application program AP is mapped in the memory region for the flash memory 17, and a self-rewriting program WP is mapped in the memory region for the mask ROM 10.

On the other hand, when the value of the mode switch register 18a is 0 (in the case of self-rewriting mode), a memory map MM2 maps, as shown in FIG. 2(b), a memory region for another memory in a region that was the memory region for the flash memory 17 in the normal mode, and also maps a memory region for the flash control register 18 succeeded by the memory region for the mode switch register 18a for performing a rewriting operation for the flash memory 17.

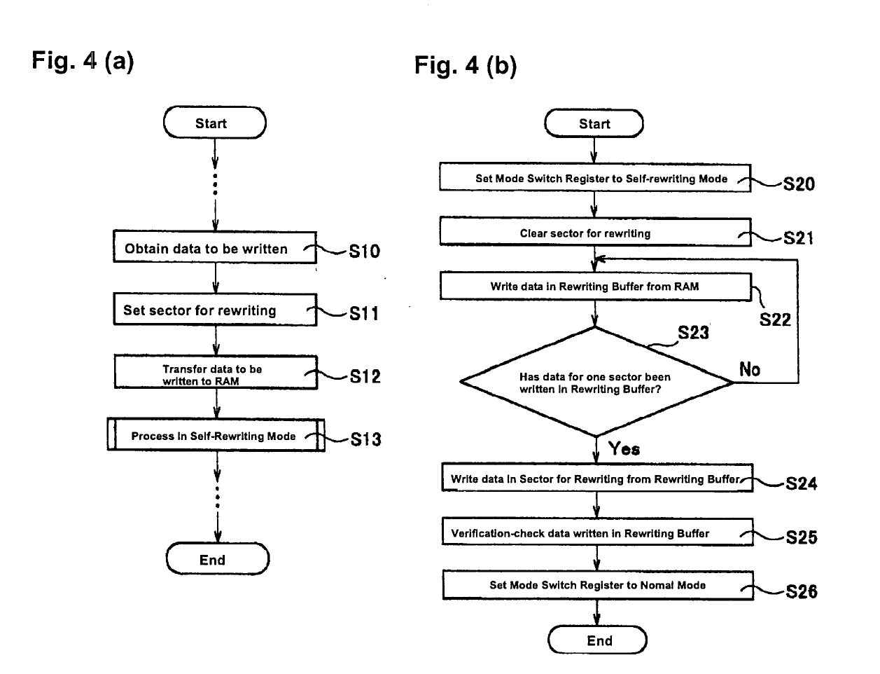

Next, referring to FIGS. 1 through 3, a rewriting process for the flash memory 17 in the self-rewriting mode by the microcomputer 1 is described according to a flowchart shown in FIG. 4. In the following description, basic processes in the rewriting process for the flash memory 17 in the self-rewriting mode are described. FIG. 4 shows flowcharts of the rewriting process in the self-rewriting mode in the microcomputer, wherein (a) is a flowchart of processes performed by an application program, and (b) is a flowchart of processes performed by a self-rewriting program.

It is noted that, in the application program AP, the rewriting process for the flash memory 17 in the self-rewriting mode is programmed by the user, in order to store various data generated during the execution of the applications.

The microcomputer 1 executes by the CPU 2 the application program AP stored in the flash memory 17. At this moment, the value 1 is set at the mode switch register 18a, and the CPU 2 operates in the normal mode according to the memory map MM1.

First, the CPU 2 obtains a variety of data (i.e., writing data for the flash memory 17), such as, data that is input during the execution of the application, data that is calculated during the execution of the application, or data that is output during the execution of the application (S10).

Next, the CPU 2 selects a sector for rewriting that is to be rewritten among the sectors of the flash memory 17 (S11).

Then, the CPU 2 transfers the rewriting data obtained during the execution of the application to the RAM 9 (S12). By the processes conducted up to this point, a pre-processing for writing the writing data in the sector for rewriting of the flash memory 17 is completed, and processes in the self-rewriting mode start from this point.

The CPU 2 makes a subroutine call for the self-rewriting program WP (S13). Then, the CPU 2 executes the self-rewriting program WP stored in the mask ROM 10.

First, the CPU 2 sets the mode switch register 18a to 0, for switching to the self-rewriting mode (S20). When the self-rewriting mode is set, the memory map MM1 is switched to the memory map MM2, and a memory region for the flash control register 18 is mapped in the memory map MM2. It is noted that, by setting data at the flash control register 18, the sector for rewriting of the flash memory 17 is rewritten.

Then, the CPU 2 erases all the data for the set sector for rewriting according to the application program AP (S21).

Then, the CPU 2 has the flash control register 18 temporarily store the writing data that has been transferred to the RAM 9 one byte by one byte, and sets addresses where the one byte data are written at the flash control register 18. Further, the CPU 2 writes the one byte data that are temporarily stored in the flash control register 18 to the rewriting buffer 17b of the flash memory 17 (S22).

Then, the CPU 2 makes a determination as to whether data for one sector have been written in the rewriting buffer 17b (S23), and continues the process S22 described above until data for one sector are written.

When data for one sector has been written in the rewriting buffer 17b, the CPU 2 writes the data for one sector in the rewriting buffer 17b to the sector for rewriting (S24).

After the rewriting operation, the CPU 2 makes a verification check of the data written in the sector for rewriting and the writing data stored in the RAM 9 (S25).

After the checking operation, the CPU 2 sets a value 1 at the mode switch register 18a for switching the self-rewriting mode to the normal mode (S26). When the normal mode is set, the memory map MM2 is switched to the memory map MM1. Then, the CPU 2 continues the processes in the normal mode according to the application program AP.

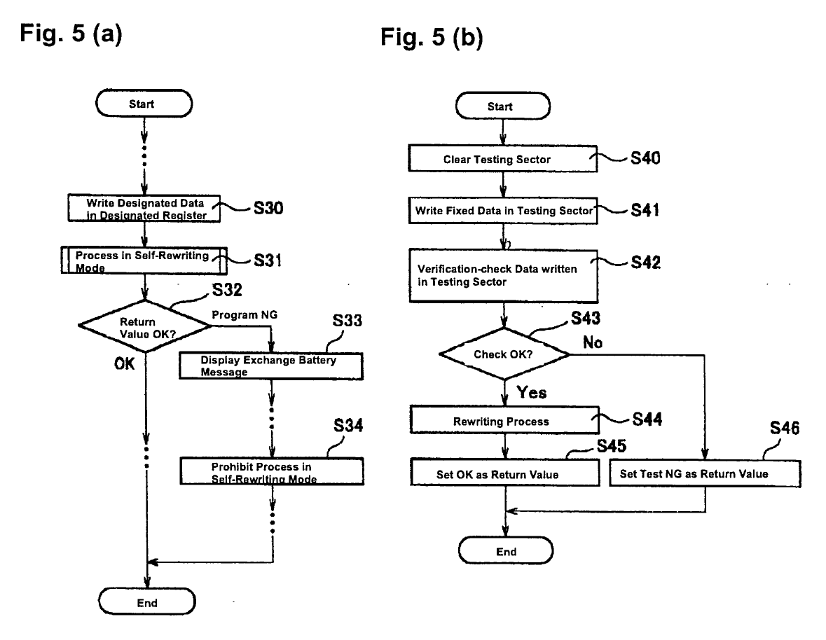

Next, referring to FIGS. 1 through 3, a rewriting test process for the flash memory 17 in the microcomputer 1 is described according to a flowchart shown in FIG. 5. The following description will be given only as to a rewriting test process that is performed to determine whether or not a rewriting operation can be normally performed before a formal rewriting process in the self-rewriting mode for the flash memory 17 is performed, and the above description for the basic processes in the rewriting process in the self-rewriting mode for the flash memory 17 is omitted. FIG. 5 shows flowcharts of the rewriting test process in the microcomputer, wherein (a) is a flowchart of processes performed by the application program, and (b) is a flowchart of processes performed by the self-rewriting program.

The microcomputer 1 executes by the CPU 2 the application program AP stored in the flash memory 17, and is operating in the normal mode.

First, the CPU 2 sets a testing sector to perform a rewriting test among the sectors of the flash memory 17 (S30). For setting the testing sector, information such as information of sectors that are not currently used, the number of rewriting operations of each sector, sectors in which the number of rewriting operations exceeds 1000 times (sectors that cannot be written) and the like is required. Such information is obtained during the execution of the application program AP, and a sector that is not currently used and is rewritable is set as a testing sector. It is noted that a testing sector can be set by the self-rewriting program WP.

It is noted that, in the present embodiment, the testing sector corresponds to a specified sector recited in the scope of claimed invention.

Next, the CPU 2 makes a sub routine call for the self-rewriting program WP (S31). Then, the CPU 2 executes the self-rewriting program WP that is stored in the mask ROM 10.

First, the CPU 2 erases all the data written in the testing sector (S40).

Then, the CPU 2 writes fixed data in the testing sector (S41). The fixed data is data that is pre-set to become different at each rewriting test process.

In the present embodiment, the fixed data serves as an example of test data recited the scope of claimed invention.

After the data has been written, the CPU makes a verification check of the data written in the testing sector and the fixed data (S42).

After the checking operation, the CPU 2 determines based on the result of the verification check as to whether the two data are entirely in accord with each other (S43).

When they are in accord with each other, a rewriting process can be normally performed, and the CPU 2 performs a formal rewriting process (S44); and upon completion of the rewriting process, sets “OK” as a return value and shifts to a processing in the normal mode (S45).

When they are not in accord with each other, a rewriting process cannot be normally performed, and the CPU 2 does not perform a formal rewriting process, sets “NG” as a return value and shifts to a process in the normal mode (S46).

Then, the CPU 2 shifts to a process in the normal mode, and judges the return value of the self-rewriting program WP (S32). When the return value is “OK”, the CPU 2 continues the processing in the normal mode.

On the other hand, when the return value is “NG”, the CPU 2 displays a battery exchange message (S33). This is to recommend to secure the voltage by changing the batteries, because there is a possibility that the reason for not being able to normally perform a rewriting operation could be a lowered voltage due to an increase in the power consumption. When the processing in the normal mode is continued without the batteries being changed, the CPU 2 prohibits a processing in the self-rewriting mode and continues the processing in the normal mode, even when a rewriting process for the flash memory 17 in the self-rewriting mode is programmed in the application program AP (S34).

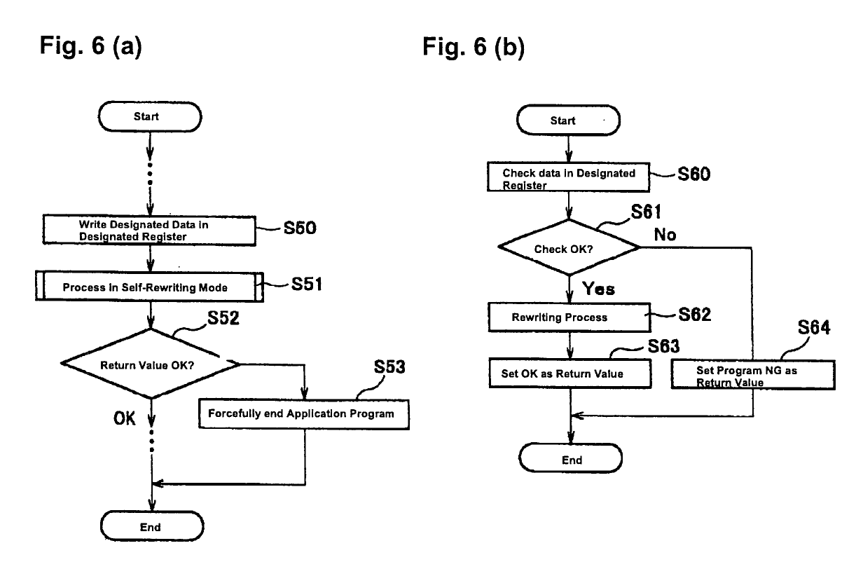

Next, referring to FIGS. 1 through 3, a program crash handling process using the register in the microcomputer 1 is described according to a flowchart shown in FIG. 6. The following description will be given only as to the program crash handling process that is performed to determine whether or not a shift to a processing in the self-rewriting mode normally took place, and the above description for the basic processes in the rewriting process in the self-rewriting mode for the flash memory 17 is omitted. FIG. 6 shows flowcharts of a program crash handling process (register) in the microcomputer, wherein (a) is a flowchart of processes performed by the application program, and (b) is a flowchart of processes performed by the self-rewriting program.

The program crash handling process uses an application program AP that programs a process to write designated data at a designated register immediately before shifting to a processing in the self-rewriting mode.

The microcomputer 1 executes by the CPU 2 the application program AP that is stored in the flash memory 17, and is operating in the normal mode.

First, the CPU 2 writes designated data at a designated register that is set by the application program AP (S50). The designated register is a register to which a specified region (a specified address region in the memory map) among unused registers is allocated. The designated data is data that is pre-set to become different at each program crash handling process.

In the present embodiment, the designated register corresponds to a predetermined region in the memory device recited in the scope of claimed invention, and the designated data corresponds to verification data recited in the scope of claimed invention.

Then, the CPU 2 makes a sub routine call for the self-rewriting program WP (S31). Then, the CPU 2 executes the self-rewriting program WP that is stored in the mask ROM 10.

First, the CPU 2 compares data stored in the designated register and the designated data (S60).

Then, the CPU judges based on the result of comparison of the two data as to whether or not the two data are in accord with each other (S61).

When they are in accord with each other, a shift to a processing in the self-rewriting mode normally took place, and the CPU 2 performs a rewriting process (S62); and upon completion of the rewriting process, sets “OK” to a return value and shifts to a processing in the normal mode (S63).

When they are not in accord with each other, a shift to a processing in the self-rewriting mode did not normally take place; and the CPU 2 does not perform a rewriting process, sets “Program NG” as a return value and shifts to a processing in the normal mode (S64). In other words, since designated data is always written in a designated register before the self-rewriting program WP is executed, a determination can be made that the self-rewriting program WP is not executed according to a normal command when the designated data is not written. In this case, if a rewriting process is performed for the flash memory 17, there is a possibility that data and programs stored in the flash memory 17 may be destroyed, and therefore a rewriting process is not performed.

Then, the CPU 2 shifts to a processing in the normal mode, judges the return value of the self-rewriting program WP (S52). When the return value is “OK”, the CPU 2 continues the processing in the normal mode.

On the other hand, when the return value is “Program NG”, the CPU 2 forcefully stops the application program AP (S53). This is because it is possible that the reason for not being able to normally shift to the self-rewriting mode may be a bug or a crash in the application program AP, and therefore the application program AP is immediately stopped.

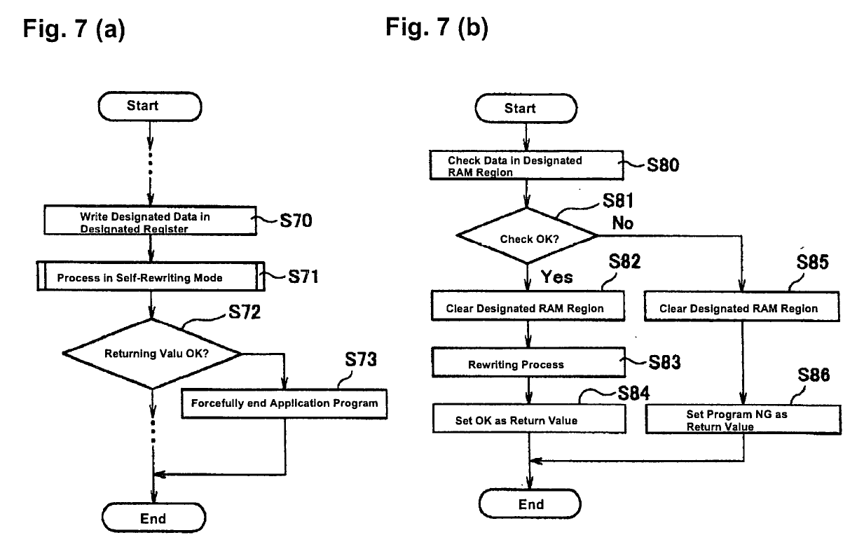

Next, referring to FIGS. 1 through 3, a program crash handling process using the RAM 9 in the microcomputer 1 is described according to a flowchart shown in FIG. 7. The following description will be given only as to the program crash handling process that is performed to determine whether or not a shift to a processing in the self-rewriting mode normally took place, and the above description for the basic processes in the rewriting process in the self-rewriting mode for the flash memory 17 is omitted. FIG. 7 shows flowcharts of a program crash handling process (RAM) in the microcomputer, wherein (a) is a flowchart of processes performed by the application program, and (b) is a flowchart of processes performed by the self-rewriting program.

The program crash handling process uses an application program AP that programs a process to write designated data at a designated RAM region immediately before shifting to a processing in the self-rewriting mode.

The microcomputer 1 executes by the CPU 2 the application program AP that is stored in the flash memory 17, and is operating in the normal mode.

First, the CPU 2 writes designated data at a designated RAM region that is set by the application program AP (S70). The designated RAM region is a specified region (a specified address region in the memory map) allocated among unused regions in the RAM 9. The designated data is data that is the same as the aforementioned designated data.

Then, the CPU 2 makes a sub routine call for the self-rewriting program WP (S71). Then, the CPU 2 executes the self-rewriting program WP that is stored in the mask ROM 10

First, the CPU 2 compares data stored in the designated RAM region and the designated data (S80).

Then, the CPU judges based on the result of comparison of the two data as to whether or not the two data are in accord with each other (S81).

When they are in accord with each other, a shift to a processing in the self-rewriting mode normally took place, and the CPU 2 erases the data in the designated RAM region (S82), and performs a rewriting process (S83). Upon completion of the rewriting process, the CPU 2 sets “OK” to a return value and shifts to a processing in the normal mode (S84).

When they are not in accord with each other, a shift to a processing in the self-rewriting mode did not normally take place; and the CPU 2 erases the data in the designated RAM region (S85), and without performing a rewriting process, sets “Program NG” as a return value and shifts to a processing in the normal mode (S86). In other words, since designated data is always written in a designated RAM region before the self-rewriting program WP is executed, a determination can be made that the self-rewriting program WP is not executed according to a normal command when the designated data is not written. In this case also, if a rewriting process is performed for the flash memory 17, there is a possibility that data and programs stored in the flash memory 17 may be destroyed, and therefore a rewriting process is not performed.

Then, the CPU 2 shifts to a processing in the normal mode, judges the return value of the self-rewriting program WP (S72). When the return value is “OK”, the CPU 2 continues the processing in the normal mode.

On the other hand, when the return value is “Program NG”, the CPU 2 forcefully stops the application program AP (S73).

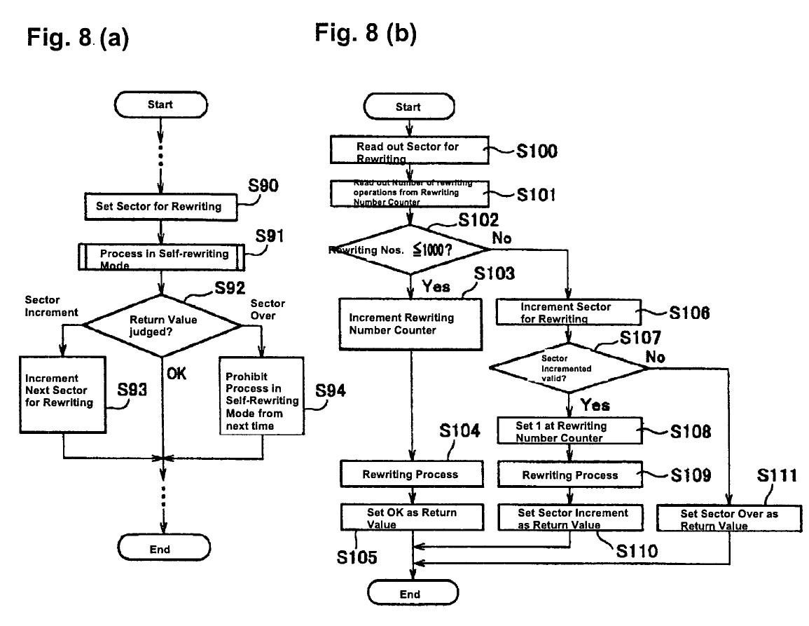

Next, referring to FIGS. 1 through 3, a rewriting number process in the microcomputer 1 is described according to a flowchart shown in FIG. 8. The following description will be given only as to a process that is performed to determine whether or not the number of rewriting operations for a sector that is set as a sector for rewriting exceeds 1000 times, and the above description for the basic processes in the rewriting process in the self-rewriting mode for the flash memory 17 is omitted. FIG. 8 shows flowcharts of a rewriting number process in the microcomputer, wherein (a) is a flowchart of processes performed by the application program, and (b) is a flowchart of processes performed by the self-rewriting program.

The microcomputer 1 executes by the CPU 2 the application program AP that is stored in the flash memory 17, and is operating in the normal mode.

First, the CPU 2 sets a sector for rewriting that is to be rewritten among the sectors of the flash memory 17 (S90). It is noted that sectors for rewriting are programmed such that when the number of rewriting operations in one sector exceeds 1000 times, it is shifted to a sector that is mapped in one upper region (successively, sector 1→sector 2→ . . . →sector n−1→sector n, as indicated in FIG. 3).

Then, the CPU 2 makes a sub-routine call for the self-rewriting program WP (S91). Then, the CPU 2 executes the self-rewriting program WP stored in the mask ROM 10.

First, the CPU 2 reads out the sector for rewriting (S100), and reads out the number of rewriting operations that is set in the rewriting number counter 17a of the sector for rewriting (S101).

Then, the CPU judges as to whether or not the number of rewriting operations read out exceeds 1000 times (S102).

When the number of rewriting operations is less than 1000, a rewriting operation for the sector for rewriting is possible, and the CPU 2 adds “1” to the number of rewriting operations read out, and sets the same at the rewriting number counter 17a (S103), and performs a rewriting process (S104). Upon completion of the rewriting operation, the CPU 2 sets “OK” as a return value, and shifts to a processing in the normal mode (S105).

When the number of rewriting operations exceeds 1000 times, a rewriting operation for the sector for rewriting is not possible, and therefore the CPU 2 stops a rewriting operation for the sector for rewriting that is set, and sets a sector in one upper region as a new sector for rewriting (S106). At this moment, the CPU 2 sets 1001 times at the rewriting number counter 17a of the sector at which a rewriting operation is stopped. For example, referring to FIG. 3, when the sector 1 is set as a sector for rewriting in the process S90, the sector 2 will be set as a new sector for rewriting in the process S106, and 1001 times is set at the rewriting number counter 17a of the sector 1. It is noted that, for setting a new sector for rewriting, one of sectors that can be rewritten can be randomly selected based on information obtained for the number of rewriting operations for each sector, sectors in which the number of rewriting operations exceeds 1000 times (sectors that cannot be rewritten) and the like.

After setting the new sector for rewriting, the CUP 2 judges whether or not the new sector for rewriting exceeds the sector n (S107). In other words, in the process S106, when setting a new sector for rewriting, if a sector for rewriting that has been set is a sector i, a sector i+1 is set as the new sector for rewriting. Therefore, when the sector i has been the sector n, a sector n+1 would be set as a new sector for rewriting, which does not exist in the flash memory 17. Accordingly, the process S107 determines if the newly set sector exists.

When the new sector for rewriting does not exceed the sector n, a rewriting operation is possible, and thus the CPU 2 sets 1 at the rewriting number counter 17a of the new sector for rewriting (S108), and performs a rewriting process (S109). Upon completion of the rewriting process, the CPU 2 sets “Sector Increment” as a return value, and shifts to a process in the normal mode (S110).

When the new sector for rewriting exceeds the sector n, a rewriting operation is not possible, and thus the CPU 2 does not perform a rewriting process, sets “Sector Over” as a return value and shifts to a process in the normal mode (S111).

Then, the CPU 2 shifts to a processing in the normal mode, and judges the return value of the self-rewriting program WP (S92). When the return value is “OK”, the CPU 2 continues the processing in the normal mode. When the return value is “Sector Increment”, which indicates that the sector for rewriting has been renewed, the CPU sets a sector for rewriting in the succeeding processing in the self-rewriting mode at the new sector for rewriting that has been set in the process S106 (S93), and continues the processing in the normal mode. When the return value is “Sector Over”, which indicates that no sector that can be rewritten exit in the flash memory 17, the CPU continues the processing in the normal mode, but prohibits a processing in the self-rewriting mode from the succeeding processing (S94).

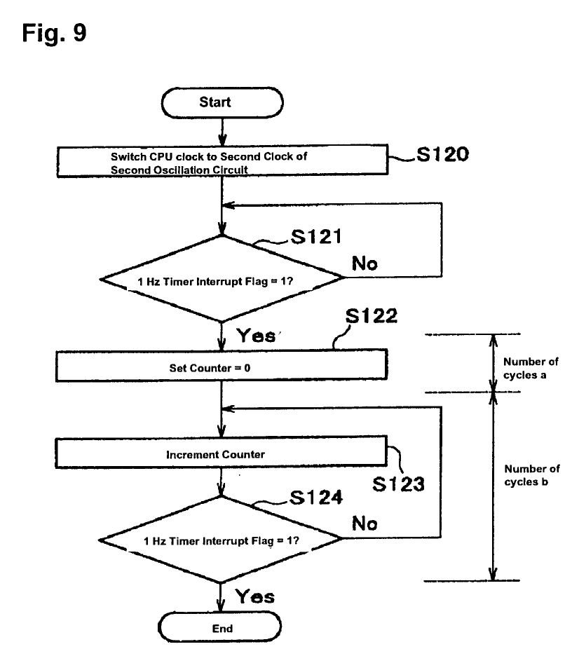

Next, referring to FIGS. 1 through 3, a cycle calculation process by the microcomputer 1 is described according to a flowchart shown in FIG. 9. FIG. 9 is a flowchart of the cycle calculation process performed by the microcomputer.

The cycle calculation process is a process for calculating high-speed and highly accurate cycles required for a rewriting operation that is performed for the flash memory 17 in the self-rewriting mode during the execution of the application program AP. More specifically, the programmable timer 6 generates required cycles using the first clock or the second clock. But, during the execution of the application program AP, the programmable timer 6 generates cycles required for applications and the second oscillation circuit 4 generates second clocks with frequencies appropriate for the cycles required for the applications. Therefore, the programmable timer 6 cannot generate a high-speed cycle that is required for the rewriting operation in the self-rewriting mode, such that a second clock with a frequency appropriate for the cycles required for the rewriting operation cannot be obtained. Accordingly, the CPU 2 calculates with the second clock a cycle required for the rewriting operation, based on the 1 Hz interrupt flag generated with the first clock according to a cycle calculation program. The cycle calculation program may be programmed in the application program AP, or may be programmed in the self-rewriting program WP, or may be an independent program. In this embodiment, the cycle calculation program is programmed in the application program AP.

The microcomputer 1 executes with the CPU 2 the application program AP stored in the flash memory 17, and is operating in the normal mode. Then, the CPU 2 starts execution of the cycle calculation program according to the application program AP.

First, the CPU 2 switches the clock to the second clock of the second oscillation circuit 4 (S120). This second clock has a frequency that is appropriate for the cycles required for the application.

Then, the CPU 2 judges whether or not a 1 Hz interrupt flag has been switched to 1 (S121). The 1 Hz interrupt flag is a highly accurate interrupt flag that is generated based on the first clock, and switches from 0 to 1 every one second.

When the 1 Hz interrupt flag switches to 1, the CPU 2 sets the counter at 0 (S122). In this instance, the CUP 2 counts the number of cycles of the second clock from the time the 1 Hz interrupt flag switches to 1 until the counter is set at 0. This number of cycles is defined as a.

Next, the CPU 2 adds 1 to the counter (S123), and judges whether the 1 Hz interrupt flag has switched to 1 (S124). In this instance, the CPU 2 counts the number of cycles of the second clock from the time it adds 1 to the counter until the judgment on the 1 Hz interrupt flag is made. This number of cycles is defined as b. Until the 1 Hz interrupt flag switches to 1, the CPU 2 repeats the execution of the processes S123 and S124.

When the 1 Hz interrupt flag switches to 1, the CPU 2 completes the calculation process by the counter. The value at the counter at this moment is assumed to be n.

Accordingly, since the number of cycles of the second clock, a+n×b, corresponds to one second, any specified cycles can be generated with the second clock, using a, b and n. When a rewriting process in the self-rewriting mode is performed, the CPU calculates a number of cycles of the second cycle for generating the cycle required for the rewriting process using a, b and n, and counts the number of cycles calculated for the second clock. For example, when cycles for m seconds are required, the number of cycles, m×(a+n×b) corresponds to m seconds in the CUP 2.

With the microcomputer 1 with the built-in flash memory 17, by programming the application program AP to make a sub routine call for the self-rewriting program WP, a rewriting process can be performed for the flash memory 17 even when the application program AP is being executed. Accordingly, with the microcomputer 1, the flash memory 17 functions as a non-volatile data storage that is capable of storing data of a large volume, and they can be constructed on a single chip. Furthermore, with the microcomputers 1, even after they are mounted on applied products, adjustment data for each of the products can be written in the flash memory 17 by using the processes in the self-rewriting mode.

Furthermore, the microcomputer 1 performs the rewriting test process to thereby stop a formal rewriting process when a rewriting operation cannot be normally performed for the flash memory 17 due to a lowered voltage or the like, and recommends to secure the required voltage. Also, the microcomputer 1 performs the program crash handling process such that a rewriting operation is not performed even after shifting to a self-rewriting mode at an inappropriate timing due to a bug that may be present in the application program AP. Therefore data or the like stored in the flash memory 17 would not possibly be destroyed. Moreover, the microcomputer 1 performs the rewriting number process such that rewriting operations can be performed for each of the sectors of the flash memory 17 until its limit in the number of rewriting operations, and even when the limit in the number of rewriting operations is exceeded in one sector, rewriting operations can be continued in another sector. Also, the microcomputer 1 performs the cycle calculation process such that high-speed and highly accurate cycles required for a rewriting operation for the flash memory 17 can be generated based on the second clock, even when the second oscillation circuit 4 is generating the second clock with a frequency appropriate for the cycles required for the operation of the application.

Next, a debugging system 20 for debugging the microcomputer 1 will be described. Here, descriptions are made particularly as to operations on the side of the debugger 21 when a process in the self-rewriting mode is performed on the side of the microcomputer 1 (target board 23).

The debugging system 20 is equipped with a debugger 21 and an ICE 22, as a system for developing the microcomputer 1. The debugging system 20 can perform debugging operations with the debugger 21, through executing an application program AP on the target board 23 of the microcomputer 1, and emulating with the ICE 22 operations of the microcomputer 1 on the target board 23.

The debugger 21 is structured as an apparatus that performs debugging operations through loading a debugging program stored in a hard disk HD of a personal computer PC onto a RAM (not shown), and executing the same by a CPU (not shown). Also, the debugger 21 reads object files OF of the application program stored in the hard disk HD, and displays sources AS of the application program AP on a display device DP. The object files OF are files in which application program source files AF are compiled and assembled. Also, the debugger 21 can be operated by the user through a keyboard (not shown) and a mouse device (not shown), and can show a variety of debugging screens on the display device DP.

Further, the debugger 21 can execute each step of the application program AP, and can perform breaks, traces and the like. Furthermore, the debugger 21 may be connected to the ICE 22 through RS 232 or the like, and can start/stop the ICE 22, and can perform operations such as referring to data on the ICE 22 and rewriting data.

The ICE 22 operates the application program AP on the target board 23 to perform emulations. Also, the ICE 22 can adjust and test the hardware on the microcomputer 1 through the target board 23.

The target board 23 is equipped with a flash memory (not shown) that stores the application program AP, a ROM (not shown) that stores a self-rewriting program WP and the like. It is noted that a one-time ROM under development or a EEPROM may be used as the ROM that stores a self-rewriting program WP.

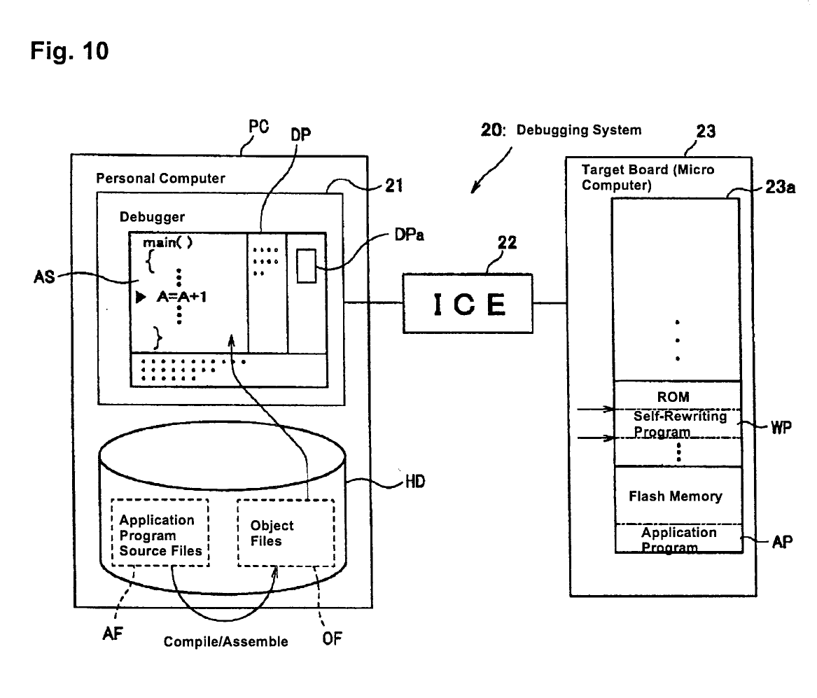

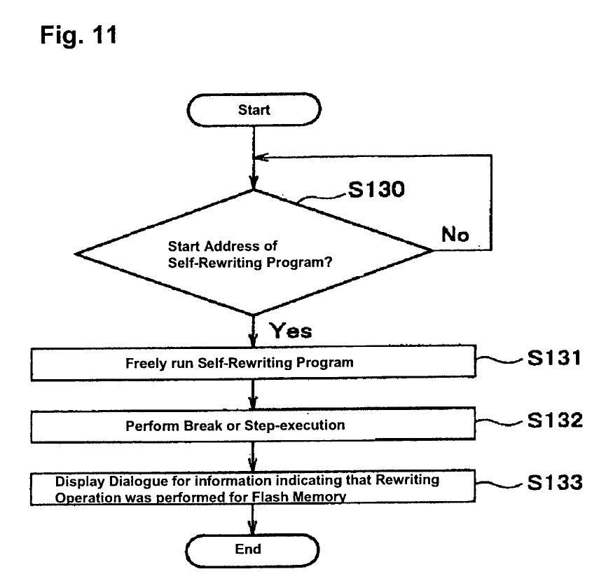

Next, referring to FIG. 10, a self-rewriting mode handling process that is performed when the debugger 21 debugs the application program AP is described according to a flowchart shown in FIG. 11. FIG. 11 shows a flow chart of the self-rewriting mode handling process by the debugger.

It is noted that a subroutine call for the self-rewriting program WP is programmed in the application program AP, in order to perform a rewriting operation for the flash memory (not shown) in the self-rewriting mode as described above. The self-rewriting program WP is directly executed while it is stored in the ROM, and thus it is mapped in a fixed address space on the memory map 23a even during its execution.

Debugging of the application program AP is started by the debugger 21. The debugger 21 monitors during the execution of the application program AP whether or not it assumes a start address of the self-rewriting program WP (the fixed address on the memory map 23a) (S130).

Then, upon detection of the start address of the self-rewriting program WP, the debugger 21, even when there is a command to perform a break or a step-execution from the user, ignores such a command and continues to execute the self-rewriting program WP until the program is completed (S131). This is because data and programs stored in the flash memory may possibly be destroyed if the rewriting process is stopped while the rewriting process is being performed for the flash memory (not shown).

Then, when there is a command to perform a break or a step-execution from the user after the execution of the self-rewriting program WP is completed (S132), the debugger 21 displays in a dialog screen DPa on the display device DP information indicating that the rewriting operation has been performed for the flash memory (S133).

This is done for the following reasons. As described above, the sources AS of the application program displayed on the display device DP are read from the object files OF on the hard disk HD. However, the application program AP that is being debugged is stored in the flash memory on the target board 23. If a rewriting operation is performed for the flash memory, there is a possibility that the sources AS of the application program displayed on the display device DP may become different from those of the application program AP that is being debugged. When the sources AS become inconsistent with the application program AP being debugged, even when the application program AP is normally executed on the target board 23, its execution results become out of coordination with the results by the sources AS that are displayed on the display device DP.

Therefore, when a rewriting operation is performed in the self-rewriting mode, such information is informed to the user. Upon recognizing, base on the information, that the application program AP has been rewritten, the user can store anew the application program source files AF on the hard disk HD, creates object files OF, and reads out sources AS after the rewriting operation on the display device DP.

With the debugger 21, when the microcomputer 1 is debugged, the self-rewriting mode handling process eliminates the possibility of destroying data while a rewriting operation is performed for the flash memory 17 in the self-rewriting mode, and can make the user recognize that the rewriting operation has been performed.

Next, descriptions are made as to two embodiment examples in which, a microcomputer (not shown) that is capable of performing a rewriting operation for a flash memory (not shown) in the self-rewriting mode is mounted on a product, and a rewriting operation is performed in the self-rewriting mode on the product. In the first embodiment example, a microcomputer is mounted on a radio controlled watch (not shown), and data is stored in a flash memory before it goes into a power-saving mode. In the second embodiment, a microcomputer is mounted on a car navigation system (hereafter called as a car navigation device), and data is stored in a flash memory before the power to the car navigation device (not shown) is turned off.

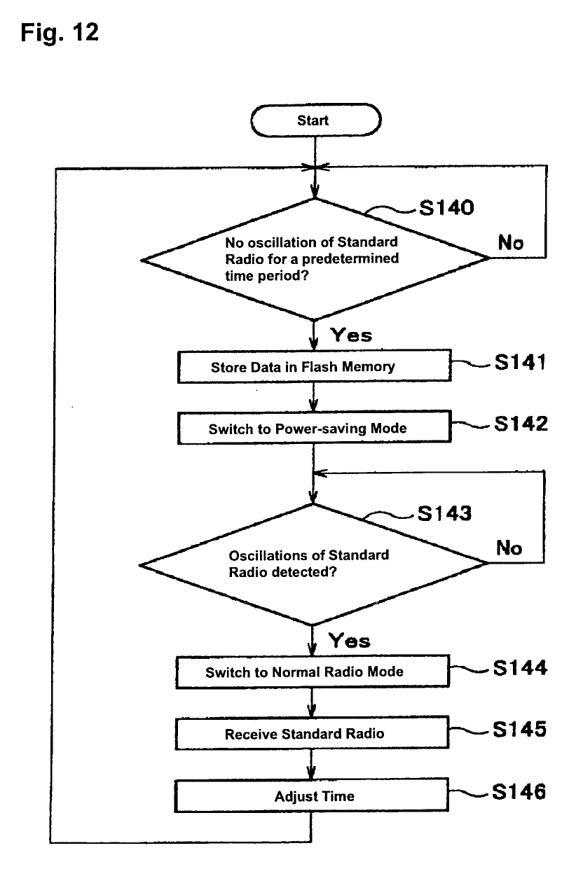

The case of the radio controlled watch where data is stored in a flash memory before it goes into a power-saving mode is described according to a flowchart shown in FIG. 12. FIG. 12 is a flowchart of processes using the self-rewriting mode in the radio controlled watch in which the microcomputer is implemented.

There may be occasions that a radio controlled watch cannot receive the standard radio signal that is the base of time depending on the seasons, weather, place of use, time bands, geographical features, buildings, non-transmission of radio due to maintenance of radio transmission facility and the like. In such a case, the radio controlled watch stops its automatic time adjustment performed with the standard radio signal in a standard radio mode, and operates in a power-saving mode with the quartz precision. Accordingly, in the radio controlled watch with the microcomputer mounted thereon, data that need to be retained, such as, the year, month, day, week, etc. are stored in the flash memory before it shifts to the power-saving mode. It is noted that an application program (not shown) for the radio controlled watch is executed on the microcomputer that is mounted on the radio controlled watch.

The radio controlled watch normally receives the standard radio signal but when oscillations of the standard radio cannot be detected, it measures the duration of time while the detection cannot be made. And the radio controlled watch determines whether or not the measured time has passed a predetermined time period (S140).

When the measured time has passed the predetermined time period, the data is stored in the flash memory in the radio controlled watch by performing the aforementioned rewriting operation in the self-rewriting mode, such that the data are retained (S141).

After storing the data, the radio controlled watch shifts to the power-saving mode, and operates with the quartz precision (S142). During this power-saving mode, the radio controlled watch judges whether or not oscillations of the standard radio signal can be detected (S143).

When oscillations of the standard radio signal can be detected, the radio controlled watch switches its mode to the standard radio mode (S144). Then, the radio controlled watch receives the standard radio signal (S145), and performs its automatic time adjustment according to the standard radio signal(S146). It is noted that, when the mode is switched to the standard radio mode, the radio controlled watch reads out the data stored in the flash memory onto a RAM (not shown) depending on the requirements.

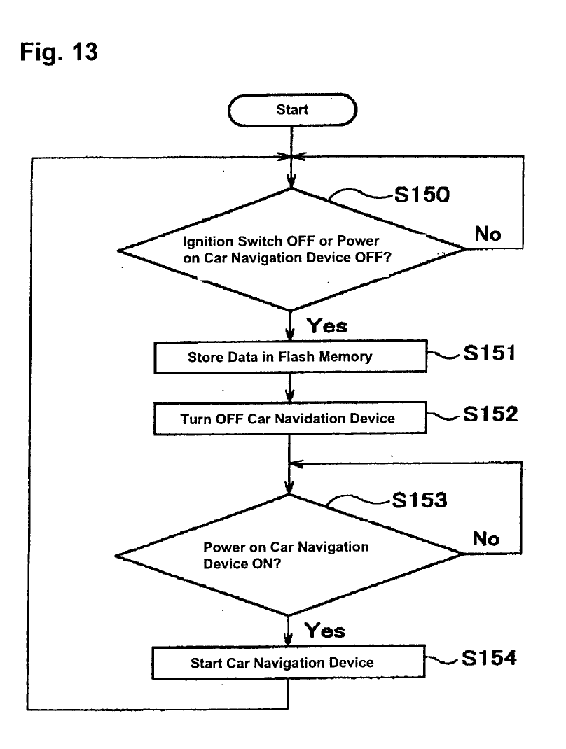

Next, the case of the car navigation device where data is stored in a flash memory before the power is turned off is described according to a flowchart shown in FIG. 13. FIG. 13 is a flowchart of processes using the self-rewriting mode in the car navigation device in which the microcomputer is implemented.

When the ignition switch is turned off, or the power on the car navigation device itself is turned off, the car navigation device must retain position data or the like for the point where they are turned off. Accordingly, in the car navigation device on which the microcomputer is mounted, data that needs to be retained is stored in the flash memory each time the power is turned off. It is noted that an application program for the car navigation device is executed on the microcomputer that is mounted on the car navigation device.

The car navigation device, while being operated with the power turned on, judges whether the ignition switch is turned off, or the power on the car navigation device itself is turned off (S150).

When either source of power is turned off, in the car navigation device, the data is stored in the flash memory by performing the aforementioned rewriting operation in the self-rewriting mode, and the data is retained (S151).

After storing the data, the car navigation device turns off the power (S152).

After the power is turned off, the car navigation device judges whether the power is turned on (S153), and starts operations according to the application program when the power is turned on (S154). It is noted that the car navigation device, when it is started, reads out the data stored in the flash memory onto a RAM depending on the requirements.

In cases such as those radio controlled watch and car navigation device in the embodiment examples, a microcomputer that is capable of performing a rewriting operation for a flash memory in the self-rewriting mode may be mounted. As a result, the flash memory can play a role of a non-volatile data storage such as an EEPROM, and can store data of a large volume.

Embodiments of the present invention have been described above, but the present invention is not limited to these embodiments and many modifications can be made.

For example, in the above embodiments, a flash memory-equipped processing apparatus in accordance with present invention is implemented in a microcomputer, but can also be implemented in other flash memory-equipped processing apparatus such as DSPs and sequencers.

Also, in the embodiments of the present invention, embodiment examples are described as to the cases where a microcomputer is mounted on a radio controlled watch or a car navigation device, and a rewriting operation is performed for a flash memory in the self-rewriting mode. In addition, the present invention can be applied to PDAs (Personal Digital Assistants), personal computers, batteries, GPSs (Global Positioning Systems), mobile telephones, a variety of audio equipment, digital cameras, measurement apparatuses (such as, power consumption meters, blood sugar level meters, thermometers, blood pressure level meters, and scales) and the like, and data and the like stored in a non-volatile memory may be stored in a flash memory before turning off the power or shifting into a power-saving mode.

Therefore, in view of the foregoing description it can be appreciated that the flash memory-equipped processor apparatus of the present invention can perform a rewriting operation for a flash memory during processing by a processing program. As a result, the processor apparatus can function the flash memory as a non-volatile data storage, and can write adjustment data or the like even after it is mounted on a variety of products.

A flash memory-equipped processor apparatus according to the present invention can stop a rewriting operation for a flash memory, when the rewriting operation cannot be normally performed due to a lowered voltage or other problems, and can make the user recognize information indicating that a rewriting operation cannot be performed for the flash memory in the self-rewriting mode.

A flash memory-equipped processor apparatus according to the present invention can judge whether or not a shift to the self-rewriting mode took place according to a normal processing of the processing program, and therefore can stop a rewriting operation for a flash memory if the it is shifted to the self-rewriting mode due to bugs or the like of the processing program.

A flash memory-equipped processor apparatus according to the present invention can perform rewriting operations for each sector up to its rewriting limit number, and can continue rewriting operations for the flash memory even the number of rewriting operations for a specified one of the sectors reaches its rewriting limit number.

A flash memory-equipped processor apparatus according to the present invention can generate cycles required for a rewriting operation for a flash memory based on the first clock and second clock, even when the second oscillation device is generating the second clock with a frequency required for the operation by the processing program in the self-rewriting mode.

A debugger apparatus according to the present invention does not destroy programs and data stored in the flash memory, even a rewriting operation is performed in the self-rewriting mode during a debugging operation.

A debugger apparatus according the present invention can make the user recognize an incident when the processing program displayed by the debugger apparatus and the processing program stored in the flash memory become inconsistent with each other as a result of a rewriting operation in the self-rewriting mode.

The entire disclosure of Japanese patent application No. 2001-274,132 filed Sep. 10, 2001.

1. A flash memory-equipped processor apparatus, which performs processing according to a processing program and rewriting for a flash memory, the flash memory-equipped processor apparatus comprising:
a mode switch register that sets a normal mode that performs processing according to the processing program and a self-rewiting mode that performs rewriting for the flash memory during execution of the processing program;
a rewriting program that programs a writing process for the flash memory; and
a control device that executes the processing program,
wherein the control device sets, during execution of the processing program, the mode switch register to the self-rewriting mode, and performs rewriting for the flash memory according to the rewriting program.

2. A flash memory-equipped processor apparatus according to claim 1, wherein the flash memory is divided into a plurality of sectors, the control device writes test data in a specified sector of the flash memory after the mode switch register is set to the self-rewriting mode, and after writing performs rewriting for the flash memory when data stored in the specified sector is in accordance with the test data.

3. A flash memory-equipped processor apparatus according to claim 1, further comprising a memory device that stores data, wherein the processing program programs a process of writing verification data in a predetermined region of the memory device before processing in the self-rewriting mode,
the control device writes verification data in a predetermined region of the memory device before setting the mode switch register to the self-rewriting mode according to the processing program, and after setting the mode switch register to the self-rewriting mode, performs rewriting for the flash memory when data stored in the predetermined region of the memory device accords with the verification data.

4. A flash memory-equipped processor apparatus according to claim 1, wherein the flash memory is divided into a plurality of sectors, wherein the sectors have rewriting number counters that set rewriting numbers,
the control device reads out a rewriting number set at the rewriting number counter of the sector to be rewritten after setting the mode switch register to the self-rewriting mode, and performs rewriting of the sector to be rewritten when the rewriting number is at a rewriting limit number or lower, and performs rewriting of a sector different from the sector to be rewritten when the rewriting number exceeds over the rewriting limit number.

5. A flash memory-equipped processor apparatus according to claim 1, further comprising a first oscillation device that generates a first clock having a constant frequency, and a second oscillation device that generates a second clock, wherein the control device calculates a specified cycle with the second clock based on a constant time formed from the first clock.

6. A flash memory-equipped processor apparatus according to claim 1, further comprising debugger apparatus that debugs the flash memory-equipped processor apparatus, wherein, when a start of execution of the rewriting program is detected during debugging, the execution of the rewriting program is not stopped halfway through thereof.

7. A flash memory-equipped processor apparatus according to claim 6, wherein, when the rewriting program is executed during debugging, information indicating that rewriting is performed at the flash memory is output.

8. A method of operating a computer processing system having a flash memory and a central processing unit (CPU), said method comprising:
a.) in a normal mode, using the CPU to execute instructions from an application program stored in the flash memory
b.) storing new write data in a volatile memory and, in response thereto, setting a mode switch register to a self-rewriting mode;
c.) transferring the new write data to a flash control register;
d.) rewriting a sector of the flash memory with the new write data; and
e.) controlling the CPU so that it returns to executing instructions from the application program after the flash memory has been rewritten.
